(19) United States
(12) Patent Application Publication
(10) Pub. No.: US 2007/0158083 A1
(43) Pub. Date: Jul. 12, 2007

(54) Extended life system to protect a home/structure from burning in a wildfire/forest fire

(76) Inventor: Kenneth Paul Duncan, Colorado Springs, CO (US)

Correspondence Address: KENNETH PAUL DUNCAN, 3125 MOONBEAM CIR. S., COLORADO SPRINGS, CO, 80916, US

(21) Appl. No.: 11/352,089

(22) Filed: Feb. 10, 2006

Related U.S. Application Data
(60) Provisional application No. 60/759,220, filed on Jan. 12, 2006.

(51) Int. Cl. A62C 35/00; A62C 37/36; A62C 37/08

(52) U.S. Cl. 169/16; 169/37; 169/19

(57) ABSTRACT

The Extended Life System to Protect a Home/Structure from Burning in a Wildfire/Forest Fire consists of a 1700+ gallon water tank (1), a standby generator (2) operating off a fuel supply of natural gas (17) or propane (17) a power transfer (3), a self priming water pump (4), a pressure booster (at least one, more if needed) (5), water lines (6), fixed, directional sprayer heads (7), temperature/smoke sensors (hereafter referred to as sensors) (8), a manual on/off switch (9), and an automatic on switch (10) The system will be a permanent fixture which will allow for the safety of a home/structure (hereafter referred to as structure) at all times, even if the owner of said structure is not available to turn the system on. The system will utilize the existing water supply (12) of any particular structure to keep the water tank full before and during use. It will also use the existing water supply, routed through a solenoid operated valve (20) to protect the landscape (15), and the walls (19) of the structure, if necessary. The water tank will also be kept as full as possible by the use of rain gutters (11) which will return the used water to the water tank. In the case of the stoppage of the existing water supply, this will add many hours to the operation of the unit. If there is an immanent danger of fire, and the owner of the structure is available, they will be able to turn the system on, and evacuate to safety. If the owner is NOT available, the sensors will turn on the system via the automatic switch when the fire gets close enough to trigger the sensors. If there is any loss of existing power (13) at the main service panel (16) the power transfer will automatically transfer power to the system from the generator, which will also start automatically in the event there is a power loss. Once the system is turned on, the water pump pumps the water to the pressure booster. The pressure booster is used to ensure proper pressure is maintained in order to assure proper coverage of the water. The water will cover the roof (14), enter the rain gutter, and return to the water tank.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to a system to protect homes/structures from wildfires/forest fires with a permanent, automatic, extended life ability to spray water on the roof of a home/structure, and if required can also protect surrounding landscaping, and the walls of the structure

This invention is the solution to the terrible losses suffered by both homeowners, and insurers, in all wildfires/forest fires to date. As populations increase, and expand into largely vegetated areas, or grassy prairies, we find that there is an ever increasing danger of the loss of real and personal property due to fire. These fires begin either by the contact of hot embers with the roof of the home/structure, or with the intense heat when the flames get to close. This invention is designed to prevent the fires caused by those occurrences.

Rooftop sprinkler systems vary in design from permanent fixtures with only existing water supplies, activated by smoke sensors using only existing power supplies, to temporary sprinkler fixtures which require the owner to be present to set the system up, to the simplicity of a garden hose which is limited in scope and also requires the owner to be present for the duration of the fire event. While permanent systems can be aesthetically damaging, they are more reliable than temporary systems. This invention will be hidden when possible and color matched to provide the least amount of negative impact on the aesthetics of the home/structure.

2. Description of Related Art

The most-closely related prior art are the following patents. U.S. Pat. No. 6,360,968, issued to Orrange, et. al. on 26 Mar., 2002. Describing a temporary system utilizing rotating sprinkler heads mounted on a plurality of legs which uses only the present pressure available, requiring the presence of a person both for setup of the system and for transferring power and water supply as opposed to being permanent in nature with fixed, directional sprayers, extra pressure, automatic startup capability, automatic transfer of power and the additional water supply being in-line between the existing supply and the system as taught by this invention. U.S. Pat. No. 6,109,361, issued to Henderson on 29 Aug. 2000. Describing a permanent system utilizing rotating sprinkler heads mounted on lines from an irrigation servo-controlled system which uses only the existing pressure supplied by the existing water supply, and requires the presence of a person to turn the system on as opposed to having fixed, directional sprayers, extra pressure, with automatic startup capability, additional power supply, automatic transfer of power, and an extra reservoir of water as taught by this system. U.S. Pat. No. 5,263,543, issued to Nigro on 23 Nov. 1993. Describing a permanent system which is automatic in nature activated by a smoke sensor, with fixed, fill circle sprayers, utilizing only existing water pressure and existing power as opposed to having fixed, directional sprayers, with extra pressure available, an alternate power source with automatic power transfer, and an extra reservoir of water as taught by this system. U.S. Pat. No. 4,330,040, issued to Ence, et. al. on 18 May 1982. Describing a permanent system for fire prevention, or cooling, with no sprinkler heads, just water lines with holes, manually controlled, using only existing water pressure, and existing power as opposed to having fixed, directional sprayer heads, manual or automatic controls, extra pressure, and an extra power supply with automatic power transfer as taught by this system.

### BRIEF SUMMARY OF THE INVENTION

Accordingly, the novel aspects of this invention are an extended life system to protect a home/structure from burning in a wildfire/forest fire which:

Protects the roof of the structure with a pattern of complete water coverage, and if necessary, the immediate landscape surrounding the structure, and the walls of the structure; is a permanent system;

which can be turned on manually, or automatically with the use of heat and smoke sensors;

using fixed, directional sprayers for less waste, placed in series wherever needed;

utilizing the existing water supply to fill the water tank;

an extra supply of water in the form of a water tank should the existing supply stop;

refilling the water tank by returning used water, via rain gutters;

using the water tank inline with the existing water supply, and pumping the water with a self priming water pump;

using a pressure booster to provide enough pressure for proper coverage of the roof,

using existing power, with a standby generator which starts automatically, available in case of power outage;

using a power transfer to transfer power automatically from the generator in case of the loss of power;

set up so the landscape and walls of the structure are watered exclusively with the existing water supply, through a solenoid operated valve, and separate pressure booster (if needed). If the existing water supply stops, this portion deactivates;

thereby allowing the water tank, with used water being returned via rain gutters, to operate as long as possible to protect the roof.

This system solves many major problems that are seen with wildfires/forest fires. It could have a huge impact on owner's insurance rates. It could reduce human suffering by reducing personal losses. It could reduce the amount of acreage burned because fire fighters would be able to concentrate on putting out the fire. It could save lives due to the automation of the system, and its extended life capability allows for the loss of both existing power supply and existing water supply.

This system will work with, or without, the presence of a person. It will make safe from fire all structures it is installed on, from residences to summer cabins to vacation homes to outbuildings.

### BRIEF DESCRIPTION OF THE DRAWINGS

FIG. 1) is a top view, layout view of the system.

FIG. 2) shows the relationship between the existing main power, the power transfer, the standby generator, the manual on/off switch, the automatic on switch, and the sensor.

FIG. 3) shows the relationship between the existing water supply, the water tank, the self priming water pump and the pressure booster.

FIG. 4) shows a side view of the system as mounted to protect the walls of the structure.

### DETAILED DESCRIPTION OF THE INVENTION

Listed below, numerically with reference to the drawings, are terms used to describe the features of this invention

1. Water tank

2. Standby generator

3. Power transfer

4. Self priming water pump

5. Pressure booster

6. Water lines

7. Fixed, directional sprayer heads

8. Heat/smoke sensors

9. Manual on/off switch

10. Automatic on switch

11. Rain Gutters

12. Existing water supply

13. Existing power supply

14. Roof

15. Landscape

16. Main electric service panel

17. Fuel supply for standby generator

18. Power connections between electric parts

19. Walls

20. Solenoid operated valve

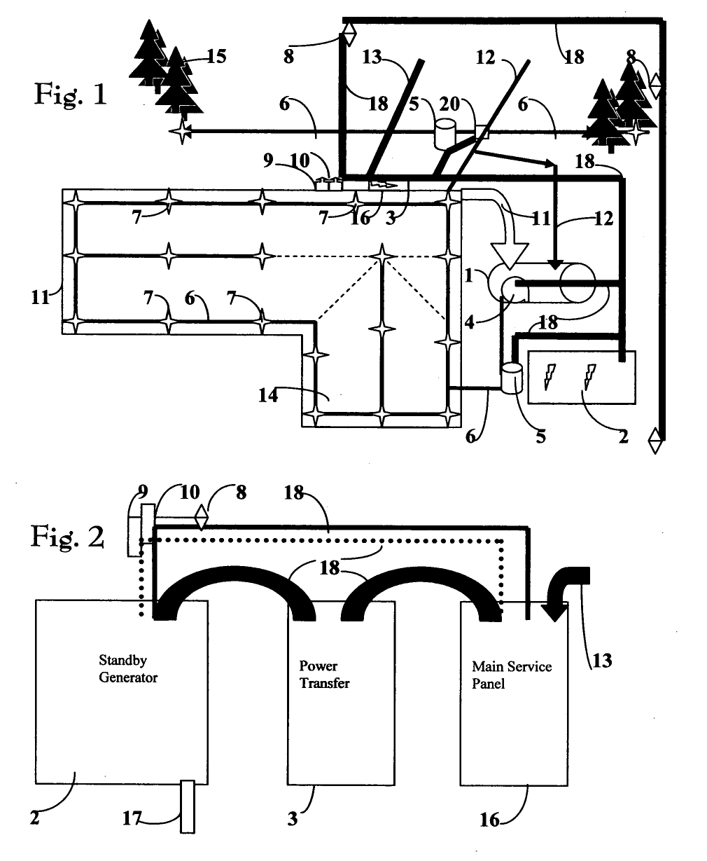

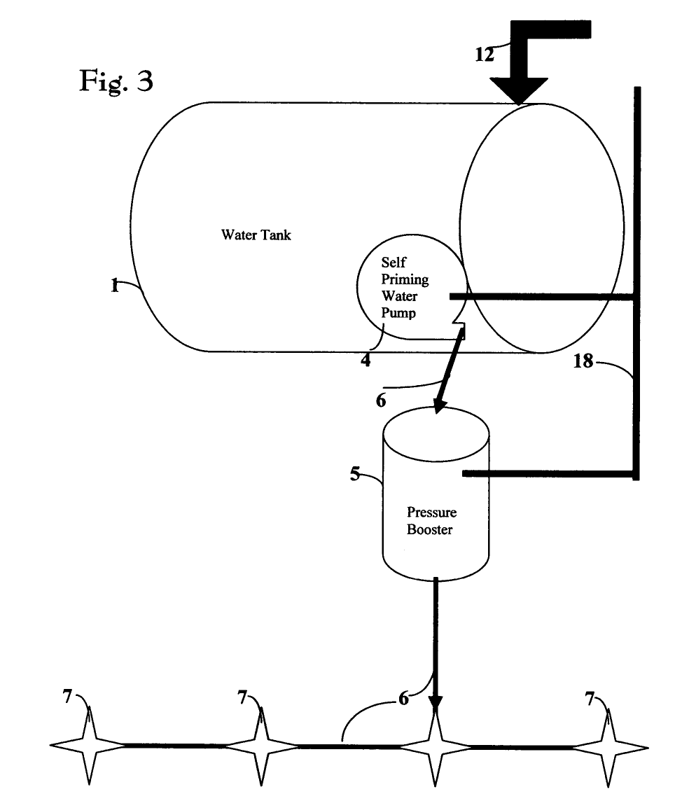

(A) The preferred embodiment for manual operation. Referring to FIG. 1, the existing power supply 13 at the main electric service panel 16, routed through the manual on/off switch 9, in-line with the automatic on switch 10, powers the self priming water pump 4, and the pressure booster 5. The system can be activated manually with the manual on/off switch 9, or automatically with the automatic on switch 10 which itself is activated by the heat/smoke sensors 8. When activated, the self priming water pump 4, which is located in the water tank 1, begins pumping water to the pressure booster 5. The pressure booster 5, which is one of the major aspects of this invention, in turn makes the water flow at pressure through the water lines 6 which are mounted along the edges and peaks of the roof 14. Assembled into the water lines 6 at specific intervals are the fixed, directional sprayer heads 7, another major feature of this invention, which will allow for full circle, half circle, and quarter circle sprays. The rain gutters 11 mounted along the edges of the roof 14 will collect the used water and return that used water to the water tank 1. This aspect of the system is one of the major features of this particular invention and is extremely important in case of the stoppage of the existing water supply 12.

(B) The preferred embodiment for automatic operation. Referring to FIG. 1, the heat/smoke sensors 8, placed strategically around the perimeter of the “protection zone” will send a signal to the automatic on switch 10. This in turn begins the process noted above in section (A).

(C) The preferred embodiment for manual or automatic operation, when there is a loss of existing power supply 13. This aspect is a major feature of this invention. Referring to FIG. 1 and FIG. 2 if, during operation, the existing power supply 13 were to be interrupted, the standby generator 2, fueled by either natural gas 17, or propane 17, would automatically begin operating. The power transfer 3, another major feature of this invention, would automatically transfer all power from the standby generator 2 to the system which would then continue with the operation of the system as noted in section (A).

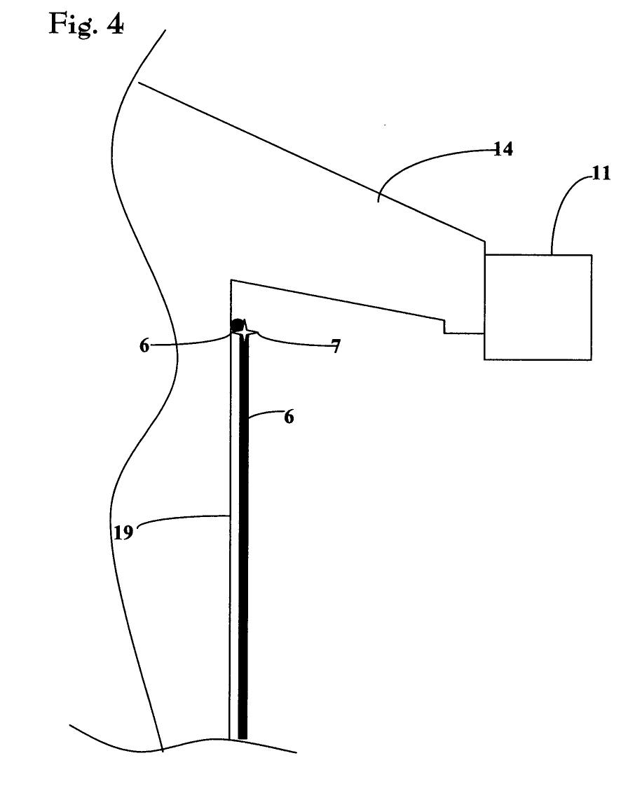

(D) The preferred embodiment for inclusion of the walls 19 and the landscape 15 in the protective scope of this invention. This separation of the landscape 15 and walls 19 is a major aspect of this invention as it pertains to the extended life of the protection of the roof 14. Referring to FIG. 1 and FIG. 4, this portion of the system uses the existing water supply 12 only. It will not use any of the water from the water tank 1 as in preferred embodiment (A). It will operate by the manual on/off switch 9 and the automatic on switch 10 just like the preferred embodiment of sections (A) or (B). It will utilize the capability of the standby generator 2 and the power transfer 3 just like the preferred embodiment of section (C). For the landscape 15 and the walls 19, there will be a separate pressure booster 5. The water to this pressure booster 5 will come through the solenoid operated valve 20 from the existing water supply 12 prior to where it enters the water tank 1. The pressure booster 5 will automatically turn off if there is a stoppage of the existing water supply 12.

It is to be noted that the particular embodiments of this invention, having been shown and described, have the foreseeable possibility of adaptation and modification without departing from this invention in its broader aspects. Therefore possible combinations of parts, applications and forms thereof, not precluded by prior art, are to be considered part of this invention.

What is claimed is:

1. An extended life system to protect a home/structure from burning in a wildfire/forest fire comprising the combination of:
a water delivery system using existing water supply delivered through a solenoid operated valve into a system including pressure booster(s), water pipes, and sprayer heads situated as to keep the roof, walls, and surrounding landscaping from combusting in the event of a wildfire/forest fire;
a water delivery system using a reservoir of water pumped with a self-priming water pump through a system including pressure booster(s), water pipes, and sprayer heads situated as to keep the roof, walls, and surrounding landscaping from combusting in the event of a wildfire/forest fire;
said water delivery systems being powered by existing power supply with the use of a manual on/off switch;
an automatic on switch for automatic operation of said water delivery systems;
said water delivery systems being powered by a standby generator, fueled by natural gas, or propane, in case of the loss of existing power;
a power transfer switch for automatic transfer of power from existing power to the standby generator in case of the loss of existing power;
a plurality of heat sensors connected to the automatic on switch to turn the system on in the absence of a human presence, in case of a rapid rise in heat, or the reaching of a set temperature
